(19) United States
(12) Patent Application Publication
(10) Pub. No.: US 2004/0090730 A1
(43) Pub. Date: May 13, 2004

(54) Active elecrostatic discharge event prediction and countermeasure using charge proximity sensing

(76) Inventors: Daniel J. Byrne, Fort Collins, CO (US); Amol S. Pandit, Greeley, CO (US); Mark N. Robins, Greeley, CO (US)

Correspondence Address: HEWLETT-PACKARD COMPANY, Intellectual Property Administration, P. O. Box 272400, Fort Collins, CO, 80527-2400, US

(21) Appl. No.: 10/291,458

(22) Filed: Nov. 8, 2002

(51) Int. Cl. H01H 47/12

(52) U.S. Cl. 361/179

(57) ABSTRACT

Electrostatic discharge (ESD) event early warning systems and methods that provide a precursor warning signal to a system that is to be protected and implements electrostatic discharge event prediction and countermeasure using charge proximity sensing. The relatively slow approach of a charged object to the system that is to be protected is sensed prior to actual discharge. In one embodiment, charge is actively switched to a guard structure designed to protect sensitive exposed circuitry of the system that is to be protected. In addition, a proximity sense signal may be used within the system that is to be protected to save data that is processed by the system, start ESD countermeasures within the system switch off sensitive subsystems of the system, or switch on grounding relays within the system.

### TECHNICAL FIELD

The present invention relates generally to electrostatic discharge events in portable electronic devices, and more specifically, to improved electrostatic discharge countermeasure event prediction and countermeasure using charge proximity sensing.

### BACKGROUND

Portable electronic devices such as digital cameras, laptop computers, handheld personal digital assistants (PDA's), and the like, are often sold with docking stations or docking cradles. These docking devices are generally connected to a host device, usually a personal computer. Often, the host device and the docking device are connected by common interface cables and protocols, such as a universal serial bus (USB) interface. In order to maintain portability and ease of use, the device to be docked (i.e.,. camera) often must interface with an input-output connector on the docking cradle. The nature of the docking cradle input-output connector is often such that the pins are exposed to electro-static discharge (ESD) events.

When an ESD event occurs on an input-output pin that happens to be connected to a personal computer, the ESD current can propagate through the docking cradle to the personal computer. ESD events can result in program disruption, data loss, unwanted personal computer user intervention, and sometimes physical damage of the personal computer's internal electronic hardware.

The ESD event poses its primary risk when there is no device in the docking station. That is, after the dockable device is inserted into a docking station, the input-output pins are no longer exposed, and no further direct threat exists.

There are many examples of conventional methods that prevent unwanted ESD discharge to this type of docking station device. Other methods of protecting a product from high levels of ESD may require the addition of additional ESD suppression components such as diodes, Zener diodes, resistors and capacitors. These components are sometimes costly, and they are subject to failure after being exposed to a large number of cycles. The number of cycles before failure is a function of applied voltage and current. Also, the addition of typical ESD suppression devices may have the highly undesirable effect of decreasing the quality of the USB signal.

U.S. Pat. No. 4,914,540 discloses that “Arcless circuit interruption from metallic contacts is accomplished by the combination of a solid state current interrupter with a control circuit and an impedance circuit. The impedance circuit diverts the contact circuit current through the solid state current interrupter prior to initiating contact separation. The contacts then open without sufficient current transfer to establish an arc.”

U.S. Pat. No. 4,636,907 discloses that “Voltage-dividing resistors, being connected in parallel to a switching element to be protected, create control voltage which is responsive to voltage applied to the switching element, to supply the same to a gate of a field effect transistor. The field effect transistor is connected in parallel to the switching element, to conduct when the control voltage exceeds a threshold value for passing overvoltage absorbing current, while causing high-frequency shorting across the switching element by its parasitic capacitance.”

U.S. Pat. No. 4,959,746 discloses “A contact protective circuit for a relay detects a transient in the relay operating coil and turns on a low resistance power MOSFET in shunt relation with the contacts before the contacts close or open whereby arcing or deposition of metal on the contracts is avoided. Timing circuitry is provided for controlling the MOSFET to conduct large direct currents for short periods of time. In one embodiment, a ramp up circuit responds to a voltage level in a control signal to drive the operating coil and power a DC-to-DC converter and a timing circuit. The invention provides for hot side switching as well as cold side switching of a load.”

U.S. Pat. No. 5,572,395 discloses “A circuit embodied within an adapter card for hot-plugging with a card slot in a card slot coupled to a processor based system utilizes a biasing circuit for ensuring that the input voltage to the load of the adapter card is of a sufficient magnitude. The circuit also includes a FET/feedback circuit for opening and closing the circuit provided between the input voltage to the adapter card and the load. This FET/feedback circuit operates as a constant current source to charge the input capacitance of the load and converts to a switched mode when the load capacitance is fully charged. The biasing circuit controls the FET/feedback circuit so that it remains open during hot-plugging of the adapter card into the card slot to alleviate pin arching. A monitor/timer circuit prevents the FET/feedback circuit from operating in the constant-current mode for no longer than a predetermined amount of time. A latch circuit is provided to turn off the FET within the FET/feedback circuit upon sensing of a transient current through the load.”

U.S. Pat. No. 6,204,571 discloses that a “multiple power supply unit includes two DC stabilized power supplies that provide electrical power in parallel to a load, each power supply providing its own operation indication to the other power supply. Each power supply changes a reference voltage used to detect excess current of its own output to the load according to whether the operation indication is received from the other power supply.”

U.S. Pat. No. 5,703,743 discloses that an “arc suppression circuit includes an insulated gate bipolar junction transistor (IGBT) connected across the electrical switch contacts to be protected. When the contacts open, the combination of added Miller capacitance and the gate-to-emitter capacitance of the IGBT results in the IGBT turning on. The IGBT is quickly turned off thereafter by a second transistor, which turns on as the voltage across the suppression circuit rises following turn-on of the IGBT. The turning on of the second transistor results in the first power transistor quickly and abruptly turning off so that relatively little of the load energy is dissipated in the power transistor.”

U.S. patent application Ser. No. 2001/0046801 discloses a “connector assembly for a handheld computer. The connector assembly includes a plurality of conductive elements disposed on a first side of a printed circuit board housed with the handheld computer. One or more of the conductive elements has a pointed end.”

However, none of the above-cited prior art patents discloses or suggests electrostatic discharge countermeasure event prediction and countermeasure using charge proximity sensing.

It is an objective of the present invention to provide for an improved method that provides for electrostatic discharge countermeasure event prediction and countermeasure using charge proximity sensing.

### SUMMARY OF THE INVENTION

To accomplish the above and other objectives, the present invention provides for an electrostatic discharge (ESD) event early warning system. The present invention provides a precursor warning signal to a system that is to be protected. More specifically, the present invention provides for electrostatic discharge event prediction and countermeasure using charge proximity sensing.

The present invention senses the relatively slow approach of a charged object to a system that is to be protected prior to actual discharge. The present invention then actively switches charge to a guard structure designed to protect sensitive exposed circuitry of the system that is to be protected.

The present invention provides an additional non-loading layer of electrostatic discharge protection for applications such as low noise, analog exposed circuitry. The present invention thus protects devices or systems that by their nature cannot be electrically loaded by filter circuitry or mechanically isolated that are unavoidably exposed to electrostatic discharge events.

In addition, electrostatic discharge (ESD) event detection and countermeasures in accordance with the present invention may be provided as follows. The proximity sense signal may be used within the system that is to be protected in a variety of ways. For example, the proximity sense signal may be used to save data processed by the system that is to be protected, start ESD countermeasures within the system that is to be protected switch off sensitive subsystems of the system that is to be protected, or switch on grounding relays within the system that is to be protected.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIG. 1 illustrates a first exemplary embodiment of an electrostatic discharge (ESD) event sensing system in accordance with the principles of the present invention;

FIG. 2 illustrates a second exemplary embodiment of an electrostatic discharge (ESD) event sensing system in accordance with the principles of the present invention;

FIG. 3 illustrates a third exemplary embodiment of an electrostatic discharge (ESD) event sensing system in accordance with the principles of the present invention; and

FIG. 4 is a flow diagram that illustrates exemplary electrostatic discharge (ESD) event sensing methods in accordance with the principles of the present invention.

### DETAILED DESCRIPTION

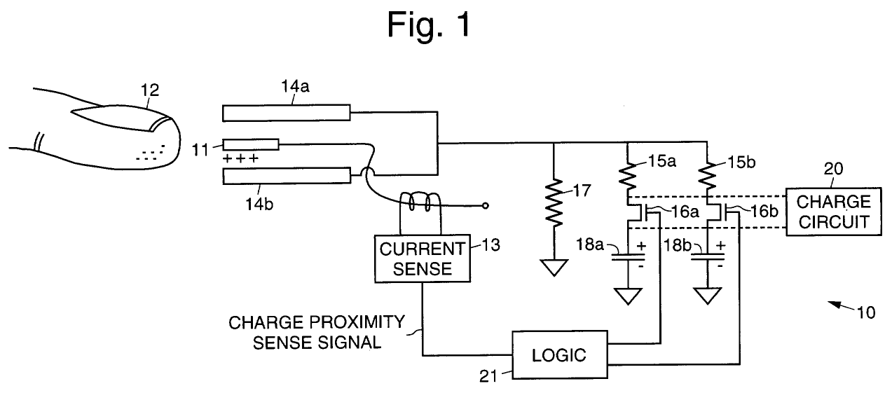

Referring to the drawing figures, FIG. 1 illustrates a first exemplary embodiment of an electrostatic discharge (ESD) event sensing system 10 in accordance with the principles of the present invention. The exemplary electrostatic discharge (ESD) event sensing system 10 is employed with a system 11 that is to be protected from electrostatic discharge events. Such events may occur when a person's finger 12 touches sensitive exposed circuitry of the system 11 that is to be protected.

The exemplary system 10 comprises a current sensing device 13 that is coupled to the system 11 that is to be protected that senses the relatively slow approach of a charged object (such as the person's finger 12) to the sensitive exposed circuitry of the system 11 that is to be protected prior to actual discharge. The current sensing device 13 generates a charge proximity sense signal in response to the approach of the charged object. Protection circuitry 25 in accordance with the present invention is coupled to the current sensing device 13 that processes the charge proximity sense signal to implement a desired electrostatic discharge countermeasure.

Exemplary protection circuitry 25 is implemented in the exemplary electrostatic discharge (ESD) event sensing system 10 shown in FIG. 1 is as follows. A plurality of guard structures 14a, 14b that are relatively large (electrically) compared to the sensitive exposed circuitry of the system 11 that is to be protected are disposed adjacent to the sensitive exposed circuitry. The plurality of guard structures 14a, 14b are coupled through respective resistors 15a, 15b to a respective plurality of switching field effect transistors 16a, 16b. The plurality of switching field effect transistors 16a, 16b are coupled through respective capacitors 18a, 18b to ground. A shunt resistor 17 is coupled to the plurality of guard structures 14a, 14b in parallel with the plurality of switching field effect transistors 16a, 16b.

A charge circuit 20 is coupled to the plurality of switching field effect transistors 16a, 16b that are used to precharge the plurality of guard structures 14a, 14b. Control circuitry 21 is coupled to the current sensing device 13 and to control gates of the respective plurality of switching field effect transistors 16a, 16b.

When current is sensed by the current sensing device 13, and with appropriate capacitors 18a, 18b selected and switched (coupled) to the guard structures 14a, 14b by the switching field effect transistors 16a, 16b under control of the control circuitry 21, the electrically large guard structures 14a, 14b draw the discharge current from the person's finger 12. Furthermore, the current is limited through the switching field effect transistors 16a, 16b by both the shunt resistor 17 and neutralization that occurs on discharge of the precharged guard structures 14a, 14b. The charge proximity sense signal output by the current sensing device 13 remains high for the duration of the presence of induced charge on the gates of the field effect transistors 16a, 16b.

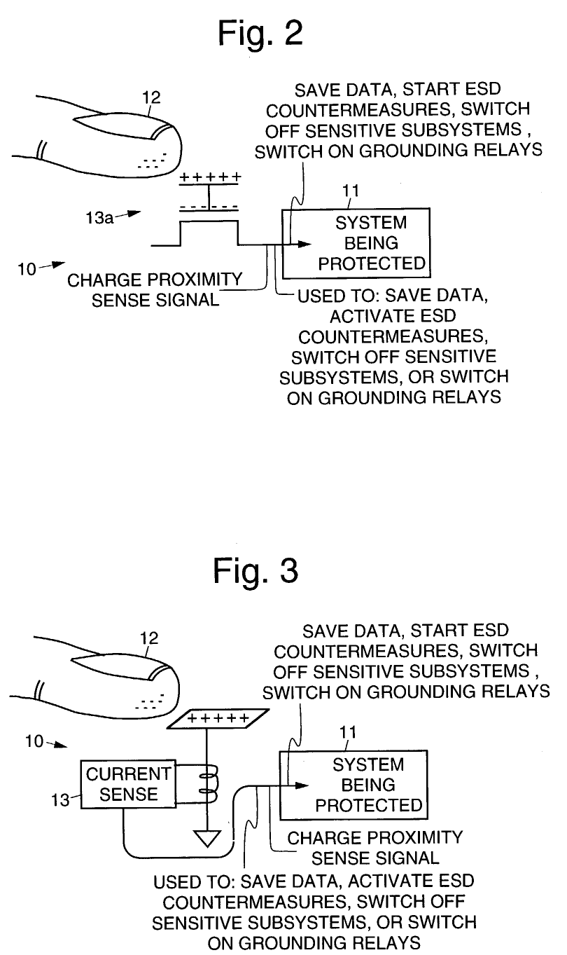

FIGS. 2 and 3 illustrate alternative embodiments of electrostatic discharge (ESD) event sensing systems in accordance with the principles of the present invention.

Referring to FIG. 2, it illustrates an electrostatic discharge (ESD) event sensing system 10 that protects a device 11 or system 11 that by their nature cannot be electrically loaded by filter circuitry or mechanically isolated, and that are unavoidably exposed to electrostatic discharge events. A charge sensing circuit 13a is coupled to the device 11 or system 11, and which outputs a charge proximity sense signal. The charge proximity sense signal is input to the device 11 or system 11 that is to be protected.

Referring to FIG. 3, it illustrates an electrostatic discharge (ESD) event sensing system 10 that employs a current sensing device 13 to sense exposure to an electrostatic discharge event. The output of the current sensing device 13 is a charge proximity sense signal that is input to the device 11 or system 11 that is to be protected when charge is detected.

In the systems 10 shown in FIGS. 2 and 3, the proximity sense signal may be used within the system 10 that is to be protected in a variety of ways to implement ESD countermeasures within the system 11. For example, the proximity sense signal may be used to save data that is processed by the system that is to be protected. The proximity sense signal may be used to switch off sensitive subsystems of the system 11 that is to be protected. In addition, the proximity sense signal may be used to switch on grounding relays within the system 11 that is to be protected.

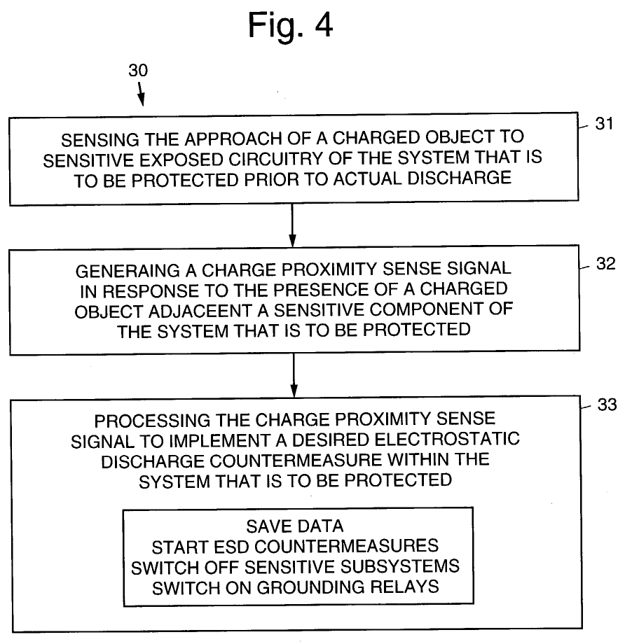

FIG. 4 illustrates an exemplary electrostatic discharge (ESD) event sensing method 30 in accordance with the principles of the present invention. The exemplary electrostatic discharge (ESD) event sensing method 30 comprises the following steps.

Charge that is unintentionally going to be coupled to sensitive exposed circuitry of a system 11 that is to be protected is sensed 31, typically for the duration of the presence of the charge. Thus, the relatively slow approach of a charged object to sensitive exposed circuitry of a system 11 that is to be protected is sensed 31 prior to actual discharge. A charge proximity sense signal is generated 32 in response to the presence of the charged object. The charge proximity sense signal is processed 33 to implement a desired electrostatic discharge (ESD) event countermeasure within the system 11 that is to be protected.

Exemplary processing 33 includes saving data that is processed by the system 11 that is to be protected, switching off sensitive subsystems of the system 11 that is to be protected, or switching on grounding relays within the system 11 that is to be protected.

Thus, systems and methods that provide for improved electrostatic discharge countermeasure event prediction and countermeasure using charge proximity sensing have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Electrostatic discharge) event sensing system apparatus for use with a system that is to be protected from electrostatic discharge events comprising:
charge proximity sensing circuitry coupled to the system that is to be protected that generates a charge proximity sense signal when a charged object is present; and
protection circuitry for processing the charge proximity sense signal to implement a desired electrostatic discharge countermeasure.

2. The apparatus recited in claim 1 wherein the charge proximity sensing circuitry, a comprises a charge sensing circuit coupled to the system that is to be protected, and which outputs a charge proximity sense signal that is input to the system that is to be protected for processing.

3. The apparatus recited in claim 1 wherein the charge proximity sensing circuitry comprises current sensing circuitry for sensing exposure of the system that is to be protected to an electrostatic discharge event, and whose output is input to the system that is to be protected for processing.

4. The apparatus recited in claim 1 wherein the protection circuitry processes the proximity sense signal to save data that is processed by the system that is to be protected.

5. The apparatus recited in claim 1 wherein the protection circuitry processes the proximity sense signal to switch off sensitive subsystems of the system that is to be protected.

6. The apparatus recited in claim 1 wherein the protection circuitry processes the proximity sense signal to switch on grounding relays within the system that is to be protected.

7. The apparatus recited in claim 1 wherein the protection circuitry comprises:
a current sensing device coupled to the system that is to be protected that senses approaching of a charged object to sensitive exposed circuitry prior to actual discharge;
a plurality of guard structures that are relatively electrically large compared to the sensitive exposed circuitry disposed adjacent to the sensitive exposed circuitry;
a plurality of switching field effect transistors coupled to the respective guard structures through a plurality of resistors and coupled to ground through respective capacitors;
a shunt resistor coupled to the plurality of guard structures in parallel with the plurality of switching field effect transistors;
a charge circuit coupled to the plurality of switching field effect transistors for precharging the plurality of guard structures; and
control circuitry is coupled to the current sensing device and to control gates of the respective plurality of switching field effect transistors.

8. A method for providing electrostatic discharge countermeasures for a system that is to be protected from electrostatic discharge events, comprising the steps of:
sensing the approach of a charged object to sensitive exposed circuitry of the system that is to be protected prior to actual discharge
generating a charge proximity sense signal in response to the presence of a charged object adjacent a sensitive component of the system that is to be protected; and
processing the charge proximity sense signal to implement a desired electrostatic discharge countermeasure within the system that is to be protected.

9. The method recited in claim 9 wherein the processing saves data that is processed by the system that is to be protected.

10. The method recited in claim 9 wherein the processing switches off sensitive subsystems of the system that is to be protected.

11. The method recited in claim 9 wherein the processing switches on grounding relays within the system that is to be protected.
